(19) United States
(12) Patent Application Publication
(10) Pub. No.: US 2016/0381560 A1
(43) Pub. Date: Dec. 29, 2016

(54) SYSTEMS AND METHODS FOR DERIVATIVE FRAUD DETECTION CHALLENGES IN MOBILE DEVICE TRANSACTIONS

(71) Applicant: OFFLA SELFSAFE LTD., Tel Aviv (IL)

(72) Inventor: Nachshon MARGALIOT, Elkana (IL)

(21) Appl. No.: 15/184,818

(22) Filed: Jun. 16, 2016

Related U.S. Application Data
(60) Provisional application No. 62/185,590, filed on Jun. 27, 2015.
(60) Provisional application No. 62/262,347, filed on Dec. 2, 2015.

(51) Int. Cl. H04W 12/12; G06F 3/0481; H04L 29/06

(52) U.S. Cl. CPC H04W 12/12; H04L 63/08; H04L 63/10; G06F 3/0481; G06F 2221/2103; G06Q 20/4014

(57) ABSTRACT

The disclosed embodiments include systems, methods, and computer-readable media configured to provide mobile device transaction security. The techniques described in the disclosed embodiments may be used to verify a mobile device user by providing derivative fraud protection challenges. Thus, the techniques may be used to improve identification and verification of users during mobile transactions. As a result, the disclosed embodiments improve mobile security and user experience as well as enhance access control.

### CROSS REFERENCE TO RELATED APPLICATIONS

This application claims the benefits of prior filed U.S. Provisional Application No. 62/185,590, filed Jun. 27, 2015, and U.S. Provisional Application No. 62/262,347, filed Dec. 2, 2015, the content of both of which is incorporated herein by reference.

### TECHNICAL FIELD

The present disclosure relates generally to computerized systems and methods for electronic fraud detection and prevention and, more particularly, to systems and methods for providing derivative fraud detection challenges to authenticate a mobile device user in transactions involving a mobile device.

### BACKGROUND

The Internet and the prevalence of mobile devices have transformed how people communicate and conduct transactions. Not only are people increasingly connected to the Internet, but more and more devices are also being inter-connected to each other and to the Internet. However, due to the anonymous nature of the Internet and computer systems in general, the process of identifying a mobile device user in transactions involving a mobile device remains susceptible to fraud. Indeed, one with access to the mobile device may pose as the user. Thus, in order to prevent an unauthorized person from using the mobile device, additional authentication processes are often needed to verify the mobile device user.

This is especially true in situations where it is imperative to ensure that only an authorized person is using the mobile device. For example, proper verification is important when the person using a mobile device requests confidential information, executes financial transactions, restores passwords, or conducts other secure transactions, etc. However, current technologies either require the user to carry an additional security device, such as a RSA token or smartcard, or require the mobile device to be connected to a remote authentication server, such as in the case of a two-step authentication procedure. As a result, these authentication processes are too cumbersome for mobile device users and/or require the mobile devices to be online.

Accordingly, there is a need for an offline solution to improve the security of mobile device communications and transactions that is highly secure, user-friendly, fast, and reliable.

### SUMMARY

The disclosed embodiments include systems, methods, and computer-readable media configured to provide information technology security. The techniques described in the disclosed embodiments may be used to verify a mobile device user by providing derivative fraud protection challenges. Thus, the techniques may be used to improve identification and verification of users during mobile transactions. As a result, the disclosed embodiments improve mobile security and user experience as ell as enhance access control.

In the disclosed embodiments, a system may access information provided by the mobile device user. The information may comprise original answers provided by the mobile device user to a plurality of original security questions. In a further aspect, the disclosed embodiments may determine a plurality of derivative security questions and a plurality of corresponding derivative answers. The derivative security questions and answers may be based on the original answers provided by the mobile device user and the plurality of original security questions.

In a further aspect, disclosed embodiments may present to the mobile device user a security challenge. For example, the security challenge may include a derivative security question. The disclosed embodiments may receive a response from the mobile device user. In one aspect, the disclosed embodiments may determine an accuracy of the response received from the mobile device user. If the response is determined to be accurate, the disclosed embodiments may enable a financial transaction to proceed.

In one aspect, the disclosed embodiments may determine that the derivative security questions seek information relating to a subset of characters in the original answers. In another aspect, the disclosed embodiments may also determine that the derivative security questions seek information relating to an image associated with the original answers. In one aspect, the disclosed embodiments may also determine that the derivative security questions seek information relating to sounds associated with the original answers.

The techniques described in the disclosed embodiments may be performed by any apparatus, system, or article of manufacture. It is understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate several embodiments and, together with the description, serve to explain the disclosed principles. In the drawings:

FIG. 1 is a schematic diagram of an exemplary system that may be used to provide user authentication based on derivative fraud detection challenges in accordance with disclosed embodiments.

FIG. 2 is a schematic diagram of another exemplary system that may be used to provide user authentication based on derivative fraud detection challenges in accordance with disclosed embodiments.

FIG. 3 is a flowchart illustrating an exemplary sequence of steps that may be performed for providing user authentication based on derivative fraud detection challenges in accordance with disclosed embodiments.

FIGS. 4a-b illustrate possible exemplary security challenges in accordance with disclosed embodiments.

FIGS. 5a-b illustrate additional exemplary security challenges in accordance with disclosed embodiments.

FIGS. 6a-b illustrate additional exemplary security challenges in accordance with disclosed embodiments.

FIG. 7 is a flowchart illustrating an exemplary sequence of steps that may be performed for determining the method of manipulation in accordance with disclosed embodiments.

FIG. 8 is a flowchart illustrating an exemplary sequence of steps that may be performed for determining derivative security questions and answers in accordance with disclosed embodiments.

### DESCRIPTION OF THE EMBODIMENTS

The disclosed embodiments provide improved techniques for providing user authentication and, more particularly, systems and methods of providing derivative fraud detection challenges during mobile device transactions. The resulting systems and method provide enhanced security, usability, and fraud detection.

Reference will now be made in detail to exemplary embodiments, examples of which are illustrated in the accompanying drawings and disclosed herein. Whenever convenient, the same reference numbers will be used throughout the drawings to refer to the same or like parts.

As used herein, the terms “mobile device” and “mobile communications device” broadly include any portable computing device having at least one processor, memory, and a capability for data communication. Mobile devices may include, but are not limited to, a mobile phone, smartphone, personal digital assistant, tablet, laptop, or other portable device. In embodiments discussed herein, such mobile devices may engage in financial transactions with merchants (e.g., via communications with POS devices).

As used herein, the term “original security question” broadly includes any type of cyber fraud detection challenge used for verification of a user. An original security question may, for example, be displayed to a user on a mobile device. In some embodiments, proceeding with a requested financial transaction is conditioned on a successful response to an original security question.

As used herein, the terms “original answer” or “original security answer” broadly include any type of response to a corresponding original security question. Similar to original security questions, original answers may be input by users, for example, on a mobile device.

As used herein, the term “derivative security question” broadly includes any type of cyber fraud detection challenge dynamically generated based on an original answer and/or original security question. The derivative security question may be displayed, for example, on a mobile device. In some embodiments, proceeding with a requested financial transaction is conditioned on a successful response to a derivative security question.

As used herein, the terms “derivative answer” or “derivative security answer” broadly include any type of response to a corresponding derivative security question. Similar to original answers, derivative answers may be input by users, for example, on a mobile device.

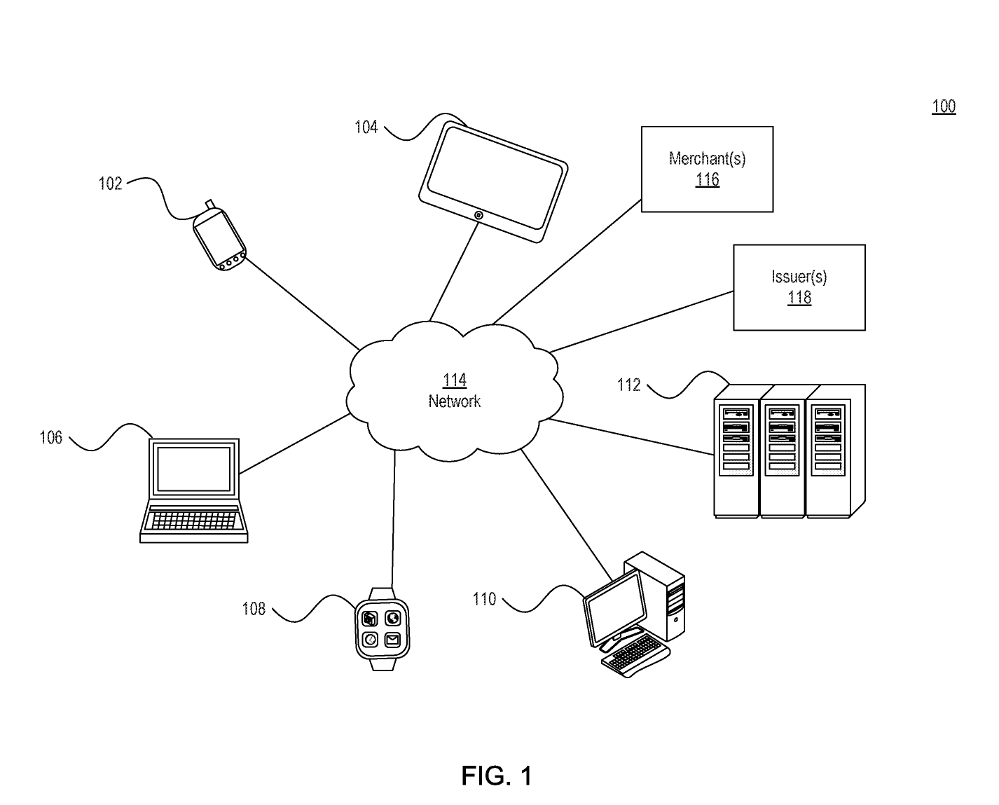

FIG. 1 is a diagram of an exemplary system 100 for performing one or more operations in accordance with the disclosed embodiments. The system 100 may comprise various components including one or more computing devices, such as computers, web servers, general-purpose servers, authentication servers, etc. The system 100 may further include memories for storing data and/or software instructions, RAM, ROM, such as databases, other computer memory devices, or the like, and may include other known computing components.

According to some embodiments, the system 100 may include one or more mobile devices 102, 104, 106, and 108 of various sizes and configurations. Although the mobile devices 102, 104, 106, and 108 are shown as a smartphone, tablet, laptop, and smartwatch for exemplary purposes of this description, it will be understood that other types of portable computing devices may also or alternatively be used in embodiments in accordance with this disclosure. As an additional example, the system 100 may also include various smart devices, such as “Internet of Things” (IoT) devices (not shown), which are capable of data communication. In some embodiments, the system 100 may also include one or more computers 110 and/or servers 112.

The mobile devices 102, 104, 106, and 108, computers 110, and/or servers 112 in the system 100 may be configured to communicate with one or more components in the system 100 via a network 114. The network 114, in some embodiments, may comprise one or more interconnected wired or wireless data networks. In one aspect, the network 114 may comprise any type of computer networking arrangement used to exchange data. For example, the network 114 may be implemented using the Internet, a wired Wide Area Network (WAN), a wired Local Area Network (LAN), a wireless WAN (e.g., WiMAX), a wireless LAN (e.g., IEEE 802.11, Bluetooth, etc.), a private data network, a virtual private network using a public network, and/or other suitable connection (e.g., Near Field Communications (NFC), infrared, etc.) that enables the system 100 to send and receive information between the components in the system 100.

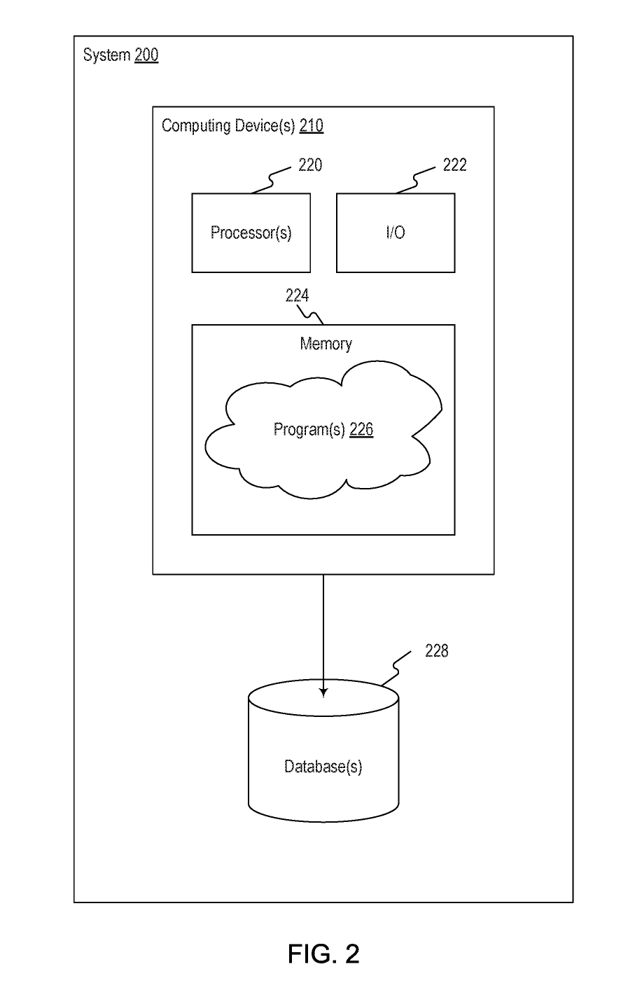

FIG. 2 is a diagram of another exemplary system for performing one or more operations in accordance with the disclosed embodiments. The exemplary system 200 or variations thereof may be implemented by the components in the system 100 (shown and not shown), including the mobile devices 102, 104, 106, and 108, smart devices, computers 110, and/or servers 112.

In some embodiments, the system 200 may include a computing device 210 having one or more processors 220, one or more input/output (I/O) devices 222, one or more memories 224, and one or more databases 228. In some embodiments, the computing device 210 may take the form of a mobile device, IoT device, personal computer, etc., or any combination of these components. Alternatively, computing device 210 may be configured as a particular apparatus, embedded system, dedicated circuit, or the like based on the storage, execution, and/or implementation of the software instructions that perform one or more operations consistent with the disclosed embodiments. In some embodiments, the system 200 may be a system-on-a-chip (SoC).

Processor 220 may include one or more known processing devices. For example, the processor 220 may take the form of, but not limited to, a microprocessor, embedded processor, or the like, or alternatively, the processor 220 may be integrated in an SoC. Furthermore, according to some embodiments, the processor 220 may be from the family of processors manufactured by Intel®, AMD®, Apple®, or the like. In some embodiments, the processor 220 may be a mobile processor.

I/O devices 222 may include one or more integrated ports or stand-alone devices configured to allow data to be received and/or transferred by computing device 210. In some embodiments, the I/O devices 222 may comprise a touchscreen configured to allow a user to interact with the computing device 210. In some embodiments, the I/O devices 222 may include one or more communication devices and/or interfaces (e.g., WiFi, Bluetooth®, RFD, NFC, RE, infrared, etc.) to communicate with other machines and devices, such as the components in the system 100. I/O devices 222 may also comprise sensors, such as gyroscopes, accelerometers, thermometers, cameras, scanners, etc.

Memory 224 may include one or more storage devices configured to store instructions used by the processor(s) 220 to perform functions related to the disclosed embodiments. For example, the memory 224 may be configured with one or more software instructions, such as included in program(s) 226, that may perform one or more operations when executed by the processor(s) 220 to provide authentication of a user or related functionality. The disclosed embodiments are not limited to separate programs or computers configured to perform dedicated tasks. For example, the memory 224 may include a single program 226 that performs the functions of the computing device 210, or alternatively, the memory 224 may include multiple software programs. Additionally, the processor 220 may execute one or more programs (or portions thereof) remotely located from the computing device 210. For example, the computing device 210 may access one or more remote programs, such that, when executed, the remote applications perform at least some of the functions related to the disclosed embodiments. Furthermore, the memory 224 may include one or more storage devices configured to store data for use by the program 226.

Computing device 210 may also be communicatively connected to one or more databases 228. For example, the computing device 210 may be communicatively connected to a database 228 through the network 114. The database 228 may include one or more memory devices that store information and are accessed and/or managed through the computing device 210. The systems and methods of the disclosed embodiments, however, are not limited to separate databases. In one aspect, the system 200 may include database 228. Alternatively, the database 228 may be located remotely from the system 200. The database 228 may include computing components (e.g., database management system, database server, etc.) configured to receive and process requests for data stored in the memory devices of the database 228 and to provide data from the database 228.

It is to be understood that the configuration and boundaries of the functional building blocks of the systems 100 and 200 have been described herein for the convenience of the description. Alternative boundaries may be defined so long as the specified functions and relationships thereof are appropriately performed. For example, the system 200 may constitute a part of components in the system 100 other than those specifically described, or may constitute a part of multiple components in the system 100. Such alternatives fall within the scope and spirit of the disclosed embodiments.

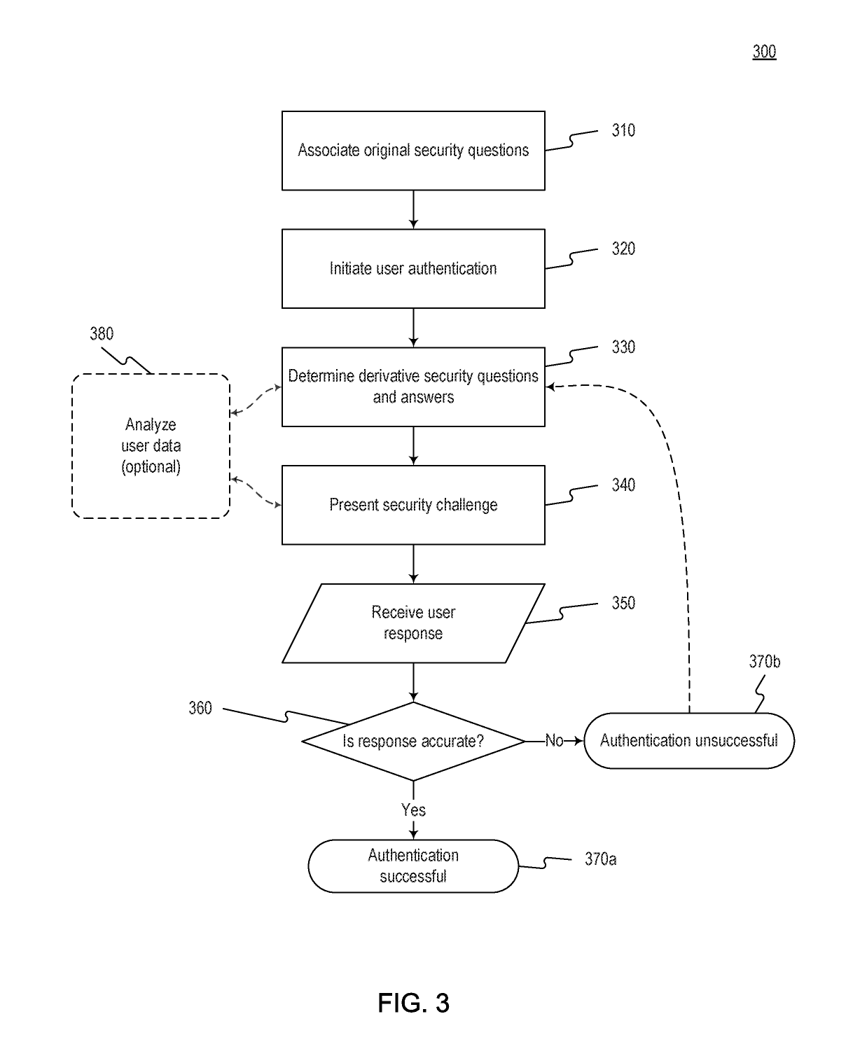

FIG. 3 shows a flowchart illustrating a sequence of steps that performs an exemplary process 300 for verifying a user in accordance with the disclosed embodiments. The process of FIG. 3 may be implemented in software, hardware, or any combination thereof. For purposes of explanation and not limitation, the process 300 will be described in the context of system 100, such that the disclosed process may be performed by software executing in mobile devices 102, 104, 106, 108, computer 110, and/or server 112.

At step 310, one or more components of the system 100 may begin by associating original security questions to a mobile device user. This may occur when the user initially opens or registers for an account, or alternatively, whenever the user resets a username and/or password. In some embodiments, the system 100 may prompt the user to select a number of original security questions from a list of available security questions. These original security questions may seek information only the user knows. For example, the questions may seek information based on the user's personal preference, such as a favorite musician, favorite place to visit, favorite teacher, etc. The questions may also seek private information related to the user, such as the name of the first grade teacher, the make and model of first car, the mother's maiden name, pet's name, birth hour of his eldest kid, place where the user met the current spouse, etc.

In some embodiments, these original security questions may be preselected by one or more components of the system 100. For example, the system 100 may have access to a database of original security questions, and upon the user registering for an account, the system 100 may select a number of original security questions from the database to be associated with the user. In some embodiments, one or more components of the system 100 may select the security questions so that each time the system 100 may need to associate original security questions to the user, the original security questions may be unique. In other embodiments, components of the system 100 may also allow the users to create their own original security questions.

Once the original security questions have been selected by either the user or one or more components of the system 100, the system 100 may prompt the user to input an answer for each original security question. In this way, by associating various original security questions to a user, the system 100 may build a database of original security questions and answers unique to the user. Alternatively, the system 100 may access existing databases from various service providers to associate the original security questions and answers to the user. For example, one or more components of the system 100 may access the user's credit card company, bank, mobile device service provider, or the like, who may have a preexisting database of original security questions and answers associated to the user.

In some embodiments, after the original security questions and answers have been associated to the mobile device user, the information may be stored within the user's mobile device 102, 104, 106, or 108. In such an embodiment, the one or more operations in exemplary process 300 may be carried out entirely within the mobile device. Thus, the mobile device may be completely offline during the one or more operations described in the exemplary process 300. In other embodiments, the information may be stored in a remote database or in a remote computer 110 and/or server 112 in the system 100 accessible by the mobile device 102, 104, 106, or 108. In such an embodiment, the mobile device, for example, may access the original security questions and answers during periods of connectivity, or alternatively, during set times. Furthermore, this could occur as a background process in the mobile device without any user interactions. For example, the mobile device 102, 104, 106, or 108 may access the remote storage during the initial setup to obtain the original security questions and answers, or whenever the mobile device needs to update the original security questions and answers stored locally within. Thus, the mobile device may only need limited connectivity at those limited times, and the one or more operations in exemplary process 300 may be carried out completely offline in the mobile device.

Once one or more components of the system 100 has associated the original security questions and answers to the user, the system 100 may provide derivative fraud detection challenges to verify the mobile device user to prevent unauthorized usage of the mobile device. For example, the mobile device user may perform certain actions on the mobile device that may require one or more components of the system 100 to verify the user before allowing the transaction. These transactions may include, for example, accessing confidential information, purchasing products or services through the mobile device, using the mobile device for payment, etc. At step 320, components of the system 100 may initiate user authentication procedures to verify the user before allowing the transaction to proceed. Thus, the user authentication procedures protect the mobile device user from unauthorized transactions.

In some embodiments, one or more components of the system 100 may, during initiation at step 320, download the original security questions and answers to the mobile device for storage if the mobile device does not have the information stored locally. Alternatively, components of the system 100 may store the information in a remote database or in a remote computer 110 and/or server 112 in the system 100 accessible by the mobile device.

After the user authentication is initiated, the system 100 may determine derivative security questions and answers at step 330. In some embodiments, the system 100 may access the information, such as the original security questions and answers, stored locally within the mobile device. In such an embodiment, the operations at step 330 may be executed by the mobile device offline and in real time. In other embodiments, the original security questions and answers may be stored remotely in system 100. In such an embodiment, the mobile device may access the remote information prior to starting the operations disclosed at step 330 of exemplary process 300. Alternatively, the operations disclosed at step 330 may be executed remotely by one or more components of the components in the system 100 including but not limited to computer 110 and/or server 112. In such an embodiment, the system 100 may determine the derivative security questions and answers in advance, and the mobile device may access the remote storage and download the derivative security questions and answers to the mobile device for storage anytime when needed.

Based on the type of original answers provided by the mobile device user and/or the type of original security questions, the system 100 may determine a suitable manipulation to determine derivative security questions and answers. For example, if the original answer is numerical, a suitable manipulation may be arithmetic operations, such as addition, subtraction, multiplication, division, etc. Other mathematical operations may also be possible depending on the desired level of difficulty for the security challenge. For example, a simple manipulation may be to find the sum of the digits in the original answer. In another aspect, a manipulation with a higher level of difficulty, for example, may be to find the suitable prime number that the original answer is divisible by. In such an example, the days in the month could be divisible by one of the following prime numbers 2, 3, 5, 7, 11, 13, 17, 19, 23, 29, and 31. In yet another aspect, the difficulty level may be due to the manipulation of one or more original security questions and/or answers. For example, the manipulation may be to find the difference between two original answers.

In another aspect, if the original answer is a word, the manipulation, for example, may be basic text operations to determine the word length, the first set of characters, the last set of characters, etc. For instance, the manipulation may be to determine the total number of characters in the original answers, or the manipulation may be to determine the first two or three letters of the original answers. In another aspect, the system 100 may also determine the manipulation based on the sounds of the original answers, for example, based on rhyming, phonetics, etc. For example, if the manipulation was to find words that rhymed with Beatles, possible words may include beetles, battles, bottles, paddles, poodles, noodles, etc. If the manipulation was to find the phonetic spelling of Beatles, possible derivative answer may be beet-lz, 'bit lz, 'bēd( [symbol] )lz, etc.

In yet another aspect, the system 100 may determine a suitable manipulation based on the original security questions. For example, if the original security questions may be represented by pictures, then the derivative answers may be pictorial representations of the original answers. As one example, if the original security questions are related to physical locations, the manipulation may be to find images of the locations. Similarly, the manipulation may be to find music, video, graphic, or the like to represent the answers. For example, if the original security questions are related to the user's favorite bands, the manipulation may be to find albums, soundtracks, voice, video, graphics, or the like related to the particular band.

Once one or more components of the system 100 selects a suitable method of manipulation, the system 100 may proceed to determine the derivative security questions and answers based on the method of manipulation. For example, the original security question may ask for the user's favorite musician, and the user's original answer may be the Beatles. In this example, the system 100 may determine that, based on the original security questions and/or answers, multiple suitable manipulations exist. In one aspect, a suitable manipulation may be to find a picture of the Beatles. In another aspect, the suitable manipulation may be to find a well-known soundtrack of the Beatles. In another aspect, the suitable manipulation may be to determine a word that rhymes with the Beatles. In yet another aspect, the suitable manipulation may be to determine the first two characters of the original answer, etc. Because multiple suitable manipulations exist, the system 100 may select the method of manipulation randomly or based on a predetermined order. Persons of ordinary skill in the art will appreciate that, for purposes of these examples, the exemplary manipulations have been described for the convenience of description.

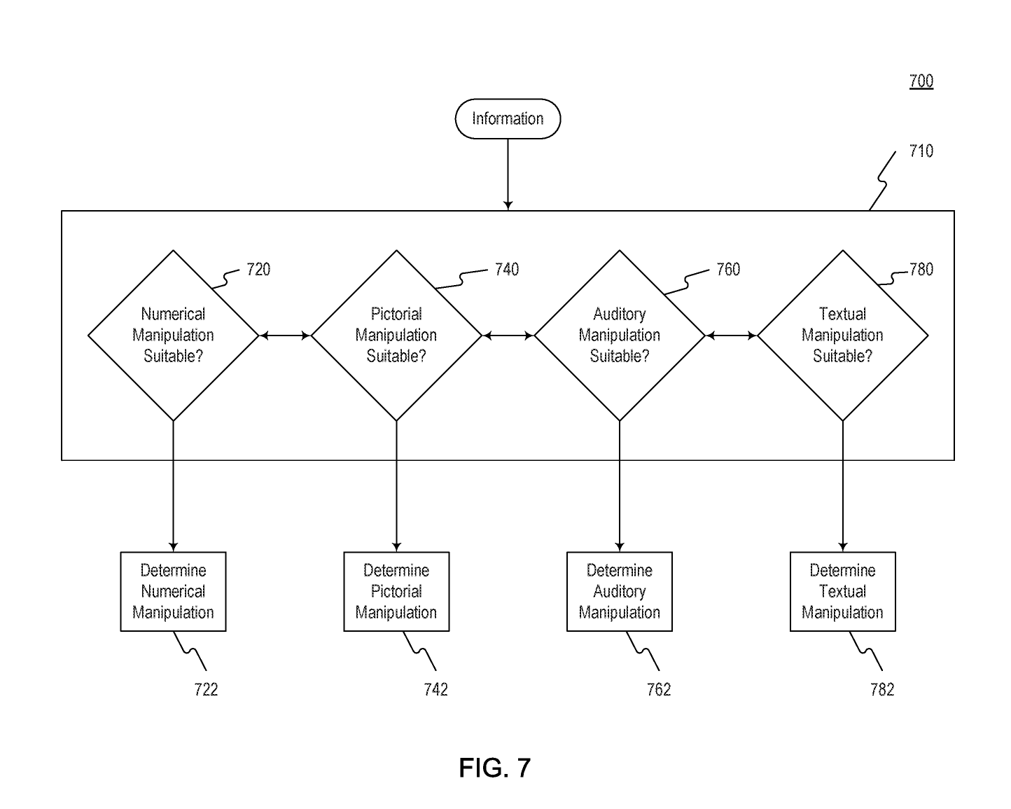

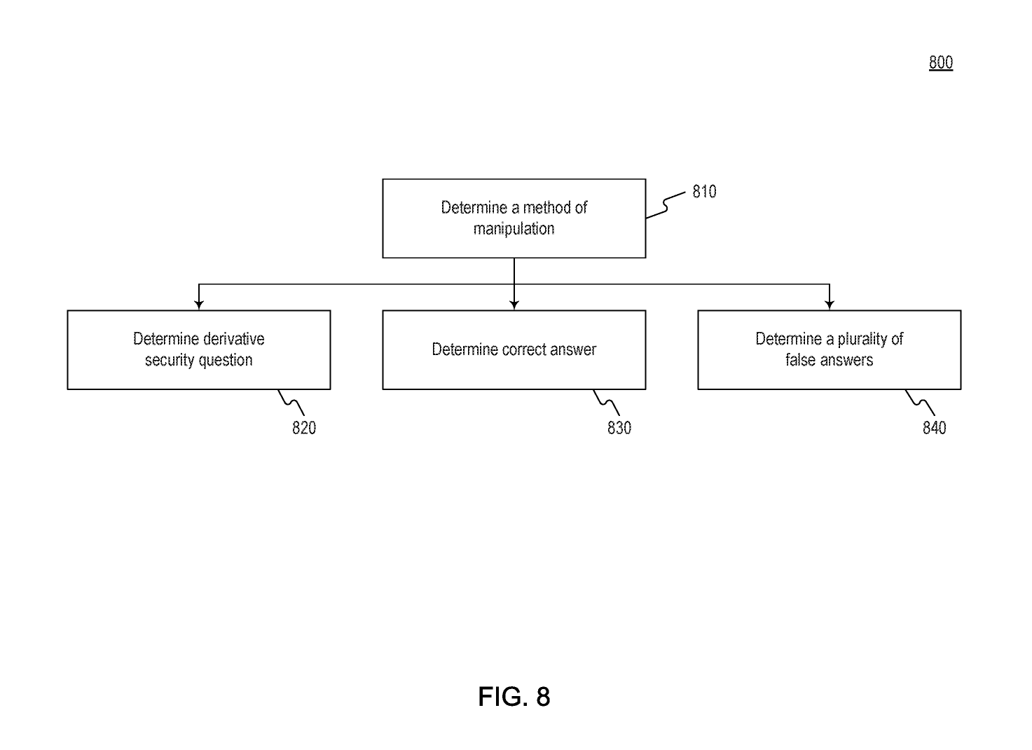

In some embodiments, once one or more components of the system 100 has determined the derivative security questions and answers, the system 100 may further determine a plurality of suitable false answers to each derivative security question. In some embodiments, the derivative security questions and answers may be determined based on the optional analysis of user data at step 380. Additional details related to these exemplary steps are further described with respect to FIGS. 7 and 8.

At step 340, one or more components of the system 100 may present the security challenge to the mobile device user. In some embodiments, the security challenge may comprise both the derivative security question and derivative security answer. For example, the system 100 may present the derivative security answer along with a plurality of possible wrong answers that could also fit the derivative security question. In this way, the process of selecting the best answer for the security challenge would be very simple. In one aspect, if the security challenge presents only one correct answer, then the user may simply select the correct answer as a response to the security challenge. Thus, the authentication process could be very simple and user friendly. In another aspect, if the security challenge presents multiple correct answers, then one or more components of the system 100 may require the user to click on a combination of correct answers as a response to the security challenge.

Furthermore, in some embodiments, one or more components of the system 100 may vary the security challenge by changing the wrong answers. In one aspect, the system 100 may select new wrong answers every time a derivative security question is presented. In another aspect, the set of wrong answers may be replaced after one or more components of the system 100 used it for a security challenge and/or after a fixed or random time has lapsed. In another aspect, the wrong answers may be replaced based on the optional analysis of user data at step 380. In some embodiments, components of the system 100 may also adjust the difficulty of the security challenge. For example, the system 100 may select the wrong answers to be as similar as possible or as different as possible from the original answers. In other embodiments, one or more components of the system 100 may select the wrong answers randomly.

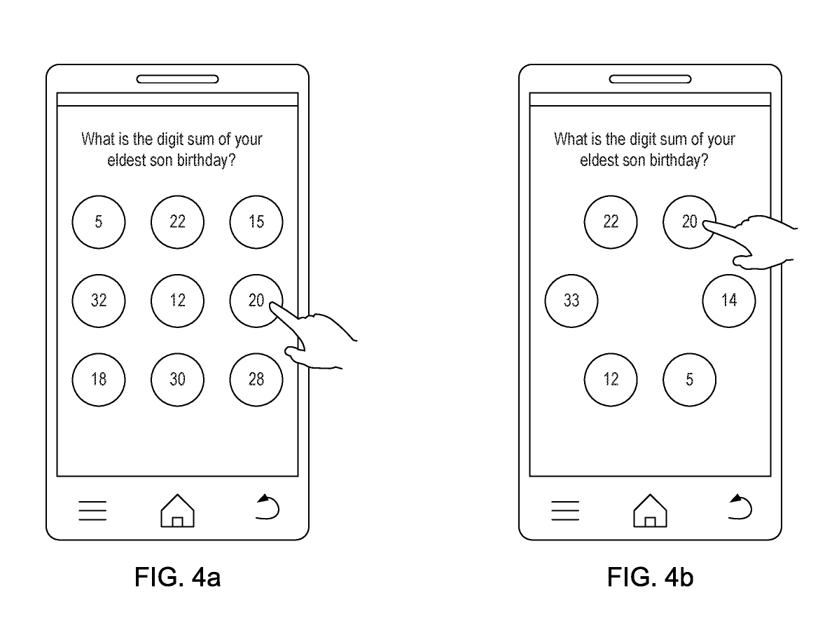

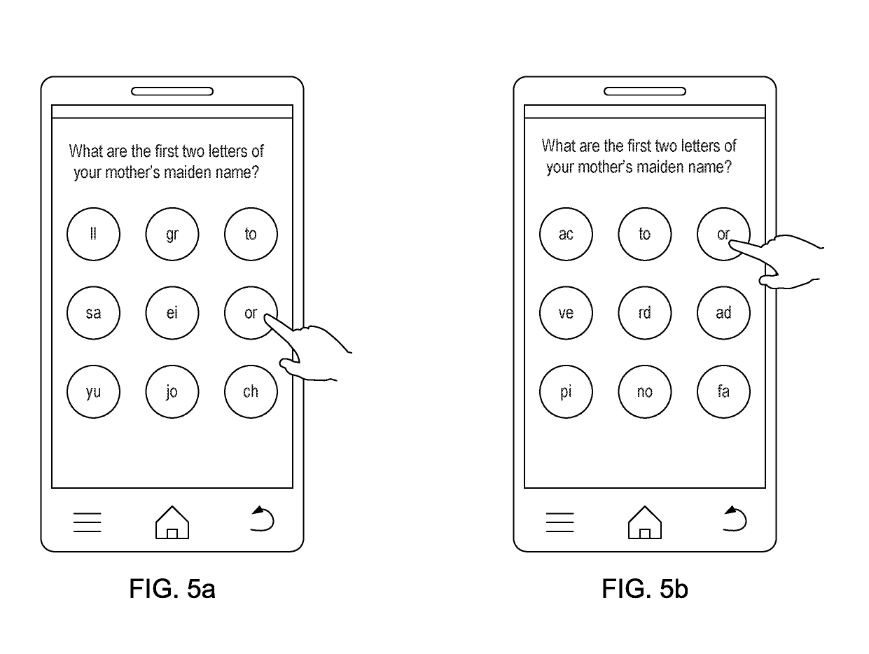

In some embodiments, one or more components of the system 100 may present the possible answers in different arrangements. For example, the security challenge may arrange the possible answers as a grid as shown in FIG. 4a or as a circle as shown in FIG. 4b. Alternatively, the possible answers may be arranged as a list, in a column, in a row, or in any shapes or configurations. In some embodiments, one or more components of the system 100 may keep the same arrangement but change the positions of the answers. For example, as shown in FIGS. 5a and 5b, the security challenge may be presented as a grid, but the position of the correct answer may vary. By changing the arrangements of the possible answers and/or the position of the correct answer, one or more components of the system 100 may prevent an unauthorized person from guessing the answer based on the location of the previous correct answer.

At step 360, one or more components of the system 100 may receive user response to the security challenge. In some embodiments, the mobile device user may use an input device, such as a stylus, mouse, trackpad, etc., to input the user's selection to the mobile device. In some embodiments, the mobile device user may use a finger to touch a capacitive touchscreen to enter the user's selection. Alternatively, the mobile device user may speak the answer, focus vision on the location of the answer on a display screen of the mobile device, or through any other input device supported by the mobile device.

At step 370, one or more components of the system 100 may compare the response with the correct derivative security answer. For example, components of the system 100 may determine an accuracy of the response received from the mobile device user. If the system 100 determines the response is accurate, then at step 370a the authentication process is successful, and one or more components of the system 100 may allow the mobile transaction to proceed. If the system 100 determines the response is not accurate, then at step 370b the authentication process is unsuccessful, and the system 100 may prevent the mobile transaction to proceed.

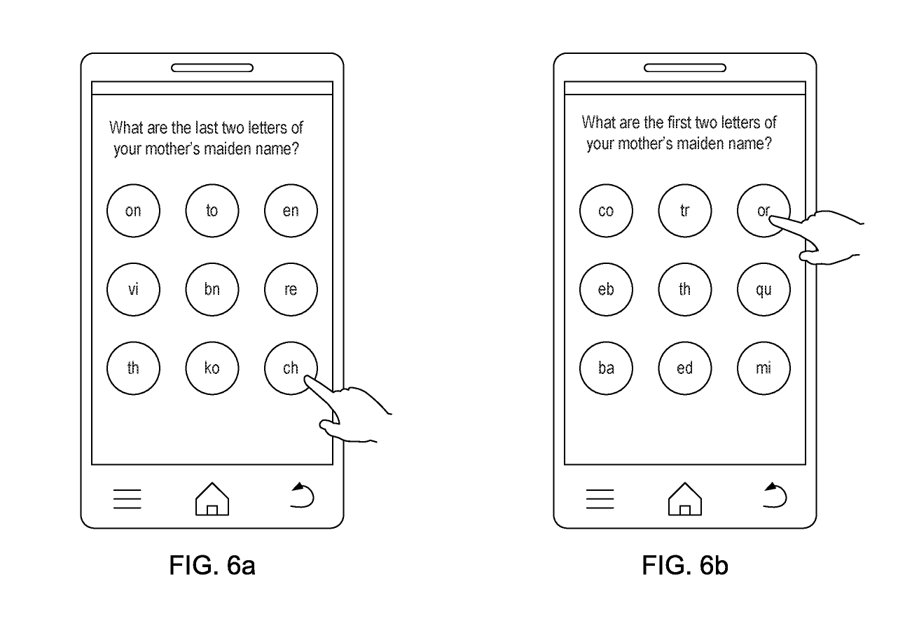

In some embodiments, one or more components of the system 100 may optionally repeat any of the steps 330 to 350. For example, the system 100 may present multiple security challenges with different derivative security questions (e.g., FIGS. 6a and 6b) or with same derivative security questions but in different ways (e.g., FIGS. 4a, 4b, 5a, and 5b). In such an embodiment, the system 100 may minimize false positives (e.g., person guessing the correct answer) or false negatives (e.g., person accidentally selecting the wrong answer).

in some embodiments, one or more components of the system 100 may optionally analyze user data at step 380. In such an embodiment, the system 100 may store various information for statistical analysis. For example, the information may comprise the number of times a particular derivative question was selected, the number of times a method of manipulation was used, the dates a particular security challenge was presented, the method of presenting a security challenge, the amount of time the user took to answer the question, etc. By measuring these user data, one or more components of the system 100 may perform statistical calculations to tailor the security challenges to the specific mobile device user and to improve the robustness of the system. For example, at step 330, the system 100 may consider one or more statistical analyses in determining derivative security questions and answers. Similarly, one or more components of the system 100 may consider one or more statistical analyses in presenting security challenges at step 340. By determining derivative security questions and answer and presenting various security challenges to the mobile device user, the system 100 may provide improved techniques for providing user authentication during mobile device transactions.

FIGS. 4a and 4b show exemplary security challenges that may be presented in accordance with disclosed embodiments. As shown in FIGS. 4a and 4b, the system 100 may use a derivative security question that asks for information related to the digit sum of a birthday. For example, the system 100 may use a numerical manipulation to determine the derivative security questions and answers.

In one aspect, the system 100 may vary the presentation of the security challenge based on the desired level of difficulty. For example, the correct answer for both exemplary security challenges in FIGS. 4a and 4b is 20, while the rest are wrong answers. Thus, the system 100 may display more answers to make the security challenge more difficult to guess (e.g., FIG. 4a) or display fewer answers to make security challenge easier to guess (e.g., FIG. 4b), etc. Accordingly, the security challenge in FIG. 4a has nine possible answers, which means that the probability of randomly guessing the correct answer is 1:9 (e.g., about 11%), while the probability of randomly guessing the correct answer in the security challenge in FIG. 4b is 1:6 (e.g., about 17%).

In another aspect, the system 100 may vary the arrangements of the possible answers, as shown in FIGS. 4a and 4b. For example, the security challenge in FIG. 4a displays the answers in a grid, while the security challenge in FIG. 4b displays the answers in a circle. Other arrangements may also be possible. By varying the arrangements of the security challenges, the system 100 may minimize the risk of shoulder surfing, where unauthorized users directly observe the location of the correct an er.

FIGS. 5a and 5b show additional exemplary security challenges may be presented in accordance with disclosed embodiments. As shown in FIGS. 5a and 5b, the system 100 may use a derivative security question that asks for information related to a rearrangement of the original answer. For example, the system 100 may use a textual manipulation to determine the derivative security question and answers.

As shown in FIGS. 5a and 5b, in yet another aspect, the system 100 may vary the position of the correct answer within a particular arrangement in order to deter shoulder surfing. Unlike FIGS. 4a and 4b where the arrangement of the answers may be different, FIGS. 5a and 5b show that the location of the correct answer within a particular arrangement may also vary. For example, in FIGS. 5a and 5b, the security challenge may display the answers in a grid, but the position of the correct answer may differ. Thus, similar to having different arrangements, the system 100 may also minimize the risk of shoulder surfing by changing the position of the correct answer.

In another aspect, FIGS. 5a and 5b also show that the system 100 may vary the use of wrong answers in the security challenge presented. For example, in FIGS. 5a and 5b, the derivative security questions both ask for information related to the first two letters of the maiden name of the user's mother. In such an example, the correct answer in FIGS. 5a and 5b is the letters “or,” while the rest are wrong answers. In presenting the security challenge, the system 100 may reuse the wrong answer for each security challenge, or as shown in FIGS. 5a and 5b, the system 100 may use a different set of wrong answers to vary the security challenges. In a further aspect, the correct answer for a derivative question may be the wrong answer for another derivative question (e.g., “ch” in FIG. 6a may be the correct answer for one derivative question but “ch” in FIG. 5a may be the wrong answer for another derivative question).

FIGS. 6a and 6b show yet another exemplary security challenges that may be presented in accordance with disclosed embodiments. As shown in FIGS. 6a and 6b, the system 100 may use derivative security questions that ask for information related to a rearrangement of the original answer. For example, the system 100 may use textual manipulations to extract the last two letters (e.g., FIG. 6a) or the first two letters (e.g., FIG. 6b) of the original security answer to determine the derivative security questions and answers.

Similar to the other variations discussed above, in yet another aspect, the system 100 may vary the derivative questions presented in the security challenge. Unlike FIGS. 5a and 5b where the security challenges may display the same derivative security question, for example, FIGS. 6a and 6b show two security challenges with different respective derivative questions. In such an example, in FIG. 6a, the derivative security question asks for the last two letters while, in FIG. 6b, the derivative security question asks for the first two letters.

FIG. 7 shows a flowchart illustrating a sequence of steps that performs an additional exemplary process 700 for determining a method of manipulation in accordance with the disclosed embodiments. The process of FIG. 7 may be implemented in software, hardware, or any combination thereof. For purposes of explanation and not limitation, the process 700 will be described in the context of system 100, such that the disclosed process may be performed by software executing in mobile devices 102, 104, 106, 108, computer 110, and/or server 112.

In accordance with disclosed embodiments, one or more components of the system 100 may analyze various information at step 710 to determine a suitable manipulation. In some embodiments, the information may comprise original security questions and/or original answers. In one aspect, components of the system 100 may determine a suitable manipulation based on the original security questions. The system 100, for example, may determine the categories the original security questions fall in. These categories may include, but are not limited to, person, place, thing, time, etc. In another aspect, one or more components of the system 100 may similarly determine the suitable manipulation based on the original answers. In yet another aspect, the system 100 may determine the suitable manipulation based on a combination of the original security questions and original answers.

During step 710, one or more components of the system 100 may analyze the original security questions and/or original answers in accordance, for example, to steps 720, 740, 760, 780. In one aspect, for example, the system 100 may consider the suitability of numerical manipulations at step 720. In another aspect, the system 100 may consider the suitability of pictorial manipulations at step 740. In another aspect, the system 100 may consider the suitability of auditory manipulations at step 760. And in yet another aspect, the system 100 may consider the suitability of textual manipulations at step 780. Persons of ordinary skill in the art will appreciate that, for purposes of these examples, the exemplary manipulations have been described for the convenience of description, and other exemplary manipulations may exist. Furthermore, these exemplary steps may be performed simultaneously, or alternatively, the steps may be performed sequential.

At step 720, one or more components of the system 100 may determine whether numerical manipulation may be suitable. In one aspect, the system 100 may make this determination based on the original security question. For example, the system 100 may determine that the original security question ask for information related to a date such as a birthday, anniversary date, or the like. Because dates could easily be converted into numerical format, one or more components of the system 100 may determine that numerical manipulation may be suitable. In another aspect, the system 100 may make this determination based on the original answer. For example, the original answer may comprise numerical characters, and the system 100 may determine that numerical manipulation may be suitable. Moreover, even if the original answer comprises alphabetic or alphanumeric characters, components of the system 100 may convert the original answer to numerical format for manipulation.

In a further aspect, after one or more components of the system 100 determines that numerical manipulation may be suitable, the system 100 may determine the specific type of numerical manipulation at step 722. In the example where the original security question asks for a specific date, such as the birthday of the mobile device user's spouse, the original answer may comprise information related to the month, day, and year of the specific birthday. In such an example, various numerical manipulations may be available. The numerical manipulation, for example, may be to extract out a particular number such as the specific month, specific day, specific year, etc. In another aspect, the numerical manipulation may comprise simple arithmetic calculations including but not limited to the sum of the numerical characters, the sum of the birth year, etc. In some embodiments, one or more components of the system 100 may determine that a plurality of original security questions and/or answers may be suitable for numerical manipulation. In such embodiments, components of the system 100 may further determine the specific numerical manipulation based on a number of such original security questions and/or answers. For example, the numerical manipulations may include but are not limited to the sum of the plurality of original answers, the difference between the original answers, etc.

In a further aspect, one or more components of the system 100 may determine whether pictorial manipulations may be suitable at step 740. In accordance with the disclosed embodiments, components of the system 100 may determine whether pictorial manipulations may be suitable based on various factors including but not limited to the original security questions, original answers, etc. Possible factors include the type of original security question, whether the original answer may be easily represented with pictures, or the like. For example, if the original security question asks for obscure information such as favorite teachers or the like, one or more components of the system 100 may determine that pictorial representation may not be suitable. Similarly, if the original answer is an obscure person, object, or place, components of the system 100 may also determine that pictorial manipulations may not be suitable because the original answer may not be easily represented with pictures. However, when the original security questions and/or original answers are related to well-known persons, objects, or places, pictorial manipulations may be suitable. In such cases, one or more components of the system 100 may use pictorial manipulation to find images of the specific person, object, or place, or other image related to such person, object, or place. For example, if the original security question asks for information related to the make and model of the mobile device user's first vehicle, the typical answer is often an easily identifiable vehicle. In such a case, the system 100 may analyze the original security question and/or answer and determine that pictorial manipulation is suitable at step 740. At step 742, components of the system 100 may determine that a suitable pictorial manipulation may be to find an image of the specific make and model of the vehicle, or to find images related to the vehicle such as the vehicle manufacturer's symbol, etc.

Pictorial manipulations, however, are not limited to original security questions and answers related to persons, objects, or places. It is to be understood that even in the birthday example discussed previously one or more components of the system 100 may determine that pictorial manipulation may also be suitable. In this example, components of the system 100 may determine that several pictorial manipulations may apply. In one aspect, the system 100, for example, may transform the month, day, and year into graphical or pictorial representations of the words and numbers. In another aspect, one or more components of the system 100 may transform the month, for example, into a picture of a holiday corresponding to that month, or a picture of the season for that month, etc.

In a further aspect, one or more components of the system 100 may analyze the information to determine whether auditory manipulations may be suitable at step 760. Auditory manipulations may include various linguistic manipulations such as determining words that rhyme with the original answers, determining phonetic equivalent, etc. In some aspects, auditory manipulations may also include finding sounds, music, soundtracks, or the like that may correspond to the original security questions and answers. Because the security challenge presented to the mobile device user may be audible, another possible auditory manipulation may be to transform the text of the original answer into audio format.

In a further aspect, one or more components of the system 100 may also determine whether textual manipulations may be suitable at step 780. Textual manipulations may include but are not limited to basic text operations such as determining the word length, the specified number of characters from the start, middle, or end of a text string, etc. In another aspect, one or more components of the system 100 may also conduct textual manipulations to combine one or more original security questions and/or answers. For example, the textual anipulation may be to concatenate two original answers to determine a possible derivative answer. Moreover, other suitable textual manipulations may be possible based on the desired level of difficulty.

Although not shown, one or more components of the system 100 may utilize various statistical analyses to determine the suitability of a particular manipulation. For example, components of the system 100 may determine the suitability of a particular manipulation based on information related to the previously presented security challenges. The information may include but is not limited to the number of times a particular method of manipulation was used, the length of time since a particular method of manipulation was chosen, the amount of time the user took to answer a question based on that a particular manipulation, etc. The information may also include the mobile device user's error rate such as the false-positive rate, the false-negative rate, etc. In some aspects, one or more components of the system 100 may also determine the suitability of a particular manipulation based on the desired difficulty level of the security challenge.

FIG. 8 shows a flowchart illustrating a sequence of steps that performs an exemplary process 800 for determining derivative security questions and answers in accordance with the disclosed embodiments. The process of FIG. 8 may be implemented in software, hardware, or any combination thereof. For purposes of explanation and not limitation, the process 800 will be described in the context of system 100, such that the disclosed process may be performed by software executing in mobile devices 102, 104, 106, 108, computer 110, and/or server 112.

In some embodiments, one or more components of the system 100 may begin the exemplary process 800 by determining a method of manipulation at step 810 in accordance to the details disclosed in exemplary process 700. In other embodiments, components of the system 100 may pre-selected the method of manipulation. In such embodiments, the system 100 may use the pre-selected method of manipulation for determining derivative security questions and answers.

At step 820, one or more components of the system 100 may determine the derivate security question based on the determined method of manipulation. In one aspect, components of the system 100 may use key portions of the original security question in combination with the method of manipulation to determine the derivate security question. For example, if the original security question asks for information related to the make and model of a vehicle, and if the system 100 is using a pictorial manipulation, then a possible derivate security question may be to identify a picture of the make and model of a vehicle. Similar combinations may be performed for other manipulation methods as well. Additional examples could be found with respect to FIGS. 4a-6b.

At step 830, one or more components of the system 100 may determine the correct answer based on the determined method of manipulation. In one aspect, the system 100 may simply perform the determined manipulation on the original answer to determine the correct answer. For example, if components of the system 100 were to perform textual manipulation, the system 100 may simply perform the manipulation to determine the correct answer. However, in some embodiments, the one or more components of system 100 may perform additional processing to determine a correct answer based on the type of security challenge. For example, if the system 100 determines that auditory manipulation may be the most suitable method but the chosen security challenge is visual based, additional processing may be required to determine a correct answer.

At step 840, one or more components of the system 100 may determine a plurality of false answers. In one aspect, the system 100 may determine the plurality of false answers by using the derivative security question. For example, components of the system 100 may randomly create false answers that may satisfy the derivative security question. In another aspect, the system 100 may determine the plurality of false answers based on the correct answer. For example, components of the system 100 may create false answers that match or may be similar to the correct answer. In yet another aspect, one or more components of the system 100 may determine the plurality of false answers using information related to other users.

Other embodiments will be apparent to those skilled in the art from consideration of the specification and practice of the disclosed embodiments. It is intended that the specification and examples be considered as exemplary only, with a true scope and spirit of the disclosed embodiments being indicated by the following claims. It is to be understood that the examples and descriptions in this disclosure have been described herein for the convenience of the description. The disclosed systems and methods are not limited to these simplified examples, and other features and characteristics may be considered so long as the specified functions are appropriately performed.

While certain disclosed embodiments have been discussed with respect to mobile devices for purposes of discussion, one skilled in the art will appreciate the useful applications of disclosed methods and systems for derivative fraud detection challenges. Furthermore, although aspects of the disclosed embodiments are described as being associated with data stored in memory and other tangible computer-readable storage mediums, one skilled in the art will appreciate that these aspects can be stored on and executed from many types of tangible computer-readable media. Further, certain processes and steps of the disclosed embodiments are described in a particular order, one skilled in the art will appreciate that practice of the disclosed embodiments are not so limited and could be accomplished in many ways. Accordingly, the disclosed embodiments are not limited to the above-described examples, but instead are defined by the appended claims in light of their full scope of equivalents.

What is claimed is:

1. A non-transitory computer readable medium storing instructions that, when executed by at least one processor, cause the at least one processor to perform derivative fraud-detection operations on a mobile device comprising:
accessing information provided by a user of the mobile device, the information comprising a plurality of original security answers provided by the mobile device user to a plurality of original security questions;
determining, based on the plurality of original security answers provided by the mobile device user and the plurality of original security questions, a plurality of derivative security questions and a plurality of corresponding derivative security answers;
presenting, on the mobile device and to the mobile device user, a security challenge, the security challenge including a derivative security question from the plurality of derivative security questions;
receiving a response from the mobile device user to the security challenge; and
determining an accuracy of the response received from the mobile device user; and
if the response is determined to be accurate, enabling a requested transaction on the mobile device to proceed.

2. The non-transitory computer readable medium of claim 1, wherein the plurality of derivative security questions seek information relating to a subset of characters in the plurality of original security answers.

3. The non-transitory computer readable medium of claim 1, wherein the plurality of derivative security questions seek information relating to an image associated with the plurality of original security answers.

4. The non-transitory computer readable medium of claim 1, wherein the plurality of derivative security questions seek information relating to sounds associated with the plurality of original security answers.

5. The non-transitory computer readable medium of claim 1, wherein the plurality of derivative security questions seek information relating to a rearrangement of characters in the plurality of original security answers.

6. The non-transitory computer readable medium of claim 1, wherein the plurality of derivative security questions seek information relating to a numerical representation of the plurality of original security answers.

7. The non-transitory computer readable medium of claim 1, wherein the security challenge comprises a graphical representation of a corresponding derivative security answer from the plurality of derivative security answers.

8. A mobile device configured to perform derivative fraud-detection operations comprising:
a memory storing executable instructions; and
at least one processor configured to execute the stored instructions to:
access information provided by a user of the mobile device, the information comprising plurality of original security answers provided by the mobile device user to a plurality of original security questions;
determine, based on the plurality of original security answers provided by the mobile device user and the plurality of original security questions, a plurality of derivative security questions and a plurality of corresponding derivative security answers;
present, on the mobile device and to the mobile device user, a security challenge, the security challenge including a derivative security question from the plurality of derivative security questions;
receive a response from the mobile device user to the security challenge; and
determine an accuracy of the response received from the mobile device user; and
if the response is determined to be accurate, enable a requested transaction on the mobile device to proceed.

9. The mobile device of claim 8, wherein the plurality of derivative security questions seek information relating to a subset of characters in the original security answers.

10. The mobile device of claim 8, wherein the plurality of derivative security questions seek information relating to an image associated with the original security answers.

11. The mobile device of claim 8, wherein the plurality of derivative security questions seek information relating to sounds associated with the original security answers.

12. The mobile device of claim 8, wherein the plurality of derivative security questions seek information relating to a rearrangement of characters in the original security answers.

13. The mobile device of claim 8, wherein the plurality of derivative security questions seek information relating to a numerical representation of the original security answers.

14. The mobile device of claim 8, wherein the security challenge comprises a graphical representation of a corresponding derivative security answer from the plurality of derivative security answers.

15. A computer-implemented method for performing derivative fraud-detection operations on a mobile device, the method comprising:
accessing information provided by a user of the mobile device, the information comprising a plurality of original security answers provided by the mobile device user to a plurality of original security questions;
determining, based on the plurality of original security answers provided by the mobile device user and the plurality of original security questions, a plurality of derivative security questions and a plurality of corresponding derivative security answers;
presenting, on the mobile device and to the mobile device user, a security challenge, the security challenge including a derivative security question from the plurality of derivative security questions;
receiving a response from the mobile device user to the security challenge; and
determining an accuracy of the response received from the mobile device user; and
if the response is determined to be accurate, enabling a requested transaction on the mobile device to proceed.

16. The computer-implemented method of claim 0, wherein the plurality of derivative security questions seek information relating to a subset of characters in the plurality of original security answers.

17. The computer-implemented method of claim 0, wherein the plurality of derivative security questions seek information relating to an image associated with the plurality of original security answers.

18. The computer-implemented method of claim 0, wherein the plurality of derivative security questions seek information relating to sounds associated with the plurality of original security answers.

19. The computer-implemented method of claim 0, wherein the plurality of derivative security questions seek information relating to a rearrangement of characters in the plurality of original security answers.

20. The computer-implemented method of claim 0, wherein the plurality of derivative security questions seek information relating to a numerical representation of the plurality of original security answers.
